(19) United States
(12) Patent Application Publication
(10) Pub. No.: US 2006/0020394 A1
(43) Pub. Date: Jan. 26, 2006

(54) Network

(75) Inventors: Elizabeth Dicke, Huntington, NY (US); Andrew Robert Byde, Wales (GB); Paul Layzell, Glos (GB); David Trevor Cliff, Southville (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/187,715

(22) Filed: Jul. 22, 2005

(30) Foreign Application Priority Data
Jul. 23, 2004 (GB) 0416484.4

(51) Int. Cl. G01N 33/48; G06F 19/00

(52) U.S. Cl. 702/19; 800/279

(57) ABSTRACT

A method of optimising a storage network comprising the steps of: defining a plurality F of flows through a set N of fabric nodes; investigating the cost of establishing some routes through the storage network; and updating a route desirability variable as a function of the cost.

### FIELD OF THE INVENTION

The present invention relates to a network, and in particular to a network allowing multiple users access to distributed storage devices.

### BACKGROUND OF THE INVENTION

There has been a tendency for offices and employees to become geographically separated while, simultaneously, both employees and organizations have sought to have unified access to company data systems almost as if they were all located at a single office. In addition, companies and users wish their data system to be robust. That is to say the communications channels and storage devices should be able to tolerate a reasonably small number of faults without loss of service. As a result storage area networks, SANs, have gained popularity with companies looking for efficient distributed storage solutions. Workers in field of storage area networks often describe a SAN as a set of “fabric elements” connecting a set of hosts to a set of storage devices. In this terminology “hosts” are computers which may need to retrieve or deposit data from the storage devices. Thus the hosts are typically user's computers. The “fabric elements” are the interconnections between the hosts and the data stores and comprise both real elements, such as cables, routers and network hubs, as well as intangible items such as a communications link having a prescribed bandwidth. The communications link may be routed through a physical cable which the company has access to, or may be a communications link provided by a third party and which, in reality, represents a share of a much faster physical data link, such as a fiber optic cable, which the third party uses to move data from one place to another. Herein the term “devices” will be used to encompass both hosts and data stores, where “fabric elements” will be used to refer to components and communications links forming the network to which the devices are connected. Devices and fabric elements are examples of Network Elements, that is components forming the network.

Each network element within the SAN has one or more ports. A port is the connection which a network element makes to a communication link and each link has a port at each end thereof.

The SAN is constructed from real world components and hence each component choice brings with it a physical limitation and a real monetary cost. It is therefore important that the components that make up the SAN are appropriately selected to achieve a suitable cost-performance balance.

The design and installation of storage area networks is a potentially very complex matter. Typically network designers and providers base their designs on a few well known topologies. This can result in SANs being over provisioned in their capabilities by quite a considerable margin. This, in turn, can result in the network installation cost, as mainly determined by the hardware components which were brought for it, being much more expensive than was strictly necessary to meet the performance criteria laid down by the user.

As noted before, a SAN is specified by providing a list of hosts (user devices that wish to access data), a list of storage devices upon which the data can be stored, a list of possible types of fabric nodes (cables, routers, hubs) and a description of the data flow requirements from a specified host to a specified storage device. The data flow requirements define the bandwidth of the data link required between the host and the storage device. These requirements are specified by a network designer based upon knowledge of the use to which the network will be put. The network designer then passes the design parameters to the SAN designer.

The SAN designer than has to juggle these user requirements with further limitations of the SAN design, such as not being able to split a data flow between a host and a device, and the limited number of ports available on each of the fabric nodes. Hewlett Packard had a project called “Appia”, reported by Ward et al, “Appia: Automatic Storage Area Network Fabric Design”, Proceedings of the FAST 2002 Conference on file and storage technologies, pages 203 to 217, January 2002, which demonstrated that algorithmic optimisation techniques could quickly specify a topology that satisfies a SAN design requirements and competed with designs created by human SAN experts. Although the Appia algorithms were able to quickly determine a possible SAN topology, they are not guaranteed to find an optimal solution.

### SUMMARY OF THE INVENTION

According to a first aspect of the present invention there is provided a method of optimising a network comprising the steps of:
a) defining a plurality F of flows through a set N of fabric nodes;
b) investigating the cost of establishing some routes through the network; and
c) updating a route desirability variable as a function of the cost.

According to a second aspect of the present invention there is provided a computer program for causing a computer to perform A method of optimising a network comprising the steps of:
a) defining a plurality F of flows through a set N of fabric nodes;
b) investigating the cost of establishing some routes through the network; and
c) updating a route desirability variable as a function of the cost.

According to a third aspect of the present invention there is provided a method of optimising a storage network configuration, the method comprising the steps of: taking an Iₜₕ set of network configurations and using genetic modification to derive from the Iₜₕ set of configurations an (I+1)ₜₕ set of configurations, having at least one change applied to them; and computing a cost for at least some of the configurations of the (I+1)ₜₕ set.

Preferably the process is iterated. Advantageously successive iterations are based on one or more solutions from a previous iteration which exhibited a comparatively low cost compared to other solutions found in that iteration. The probability that a solution is used as the basis of a further iteration may be a function, and preferably an inverse function of the cost of that solution. Thus high cost solutions have a low probability of being selected compared to lower cost solutions. Advantageously “elitism” is invoked such that the lowest cost solution from any generation is automatically included into the next generation. This ensures that irrespective of the number of iterations or generations over which the process is run, the lowest cost solution is always carried forward to the final generation.

According to a fourth aspect of the present invention there is provided a computer program for causing a computer to perform a method of optimising a storage network configuration, the method comprising the steps of:
a) taking an Iₜₕ set of network configurations and using genetic modification to derive from the Iₜₕ set of configurations an (I+1)ₜₕ set of configurations having at least one change applied to them, and
b) computing a cost for at least some of the configurations of the (I+1)ₜₕ set.

### BRIEF DESCRIPTION OF THE DRAWINGS

The present invention will now be described, by way of example, with reference to the accompanying drawings, in which:

FIG. 1 is an example of a prior art optimisation of a network using Appia;

FIG. 2 is a table defining a network data flow requirement between hosts and devices;

FIGS. 3a and 3b schematically illustrate an “ant behaviour” based approach to selecting a low cost or quickest route;

FIG. 4 illustrates the steps performed in ant optimisation;

FIG. 5 is a “genome” for a first network solution;

FIG. 6 schematically illustrates the network defined by the genome in FIG. 5;

FIG. 7 is a genome for a second solution to the network flow defined in FIG. 2;

FIG. 8 schematically illustrates the network flow defined by the genome in FIG. 7;

FIG. 9 is a genome for a third network solution;

FIG. 10 schematically illustrates the network defined by FIG. 9;

FIG. 11 schematically illustrates one process for “breeding” an offspring network from two parent networks;

FIG. 12 schematically illustrates a further process for “breeding” an offspring network from two parent networks;

FIG. 13 is a table schematically showing implementation cost and probability of breeding in a single generation of solutions;

FIGS. 14a and 14b schematically illustrate multilayer networks designed in accordance with the present invention; and

FIG. 15 shows a flow chart for genetic solution of a SAN solution.

### DESCRIPTION OF PREFERRED EMBODIMENTS OF THE INVENTION

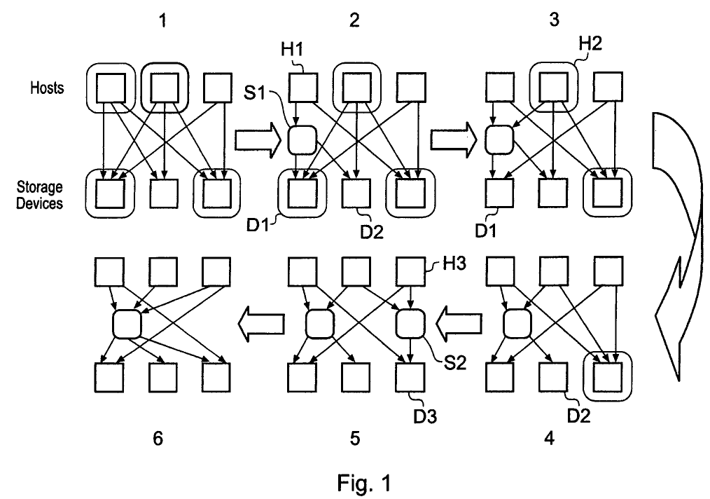

As described hereinbefore, Hewlett Packard has disclosed algorithms for storage area network design. FIG. 1 schematically illustrates six simple network configurations created by the Appia flow merge algorithm for a simple problem involving interconnecting six devices, and more specifically three hosts seeking to connect to three storage devices. This example is useful as it gives an indication of the constraints which may be imposed on even a seemingly trivial network. In this example each host and each storage device only has two ports. The design can also use switches which support eight ports. Each of the data flows has a bandwidth requirement of 22 MBs⁻¹ and the links and ports each support 100 MBs⁻¹ bandwidths. Counting the hosts and storage devices from left to right, the first hosts needs to connect to each of the three storage devices, as does the second host, whereas the third host only needs to connect to the first and third storage devices.

It can be seen that the first attempt by the flow merge algorithm results in four devices (encircled in the Figure) having port violations, that is more connections than the number of ports that the device actually has. The second iteration reduces the number of port violations by introducing a switch S1 between the first host Hi and the first device D1. The switch connects to the devices D1 and D2. In spite of this introduction of a switch there are still three port violations. The third iteration removes the direct connection between host H2 and device D1 and instead routes the data flow through the switch S1. This solution has reduced the number of port violations from three to two. The fourth iteration results in the removal of a direct connection from host H2 to device D2 and instead routes this connection via the switch S1. This has reduced the number of port violations to one. The fifth iteration sees the introduction of a second switch, S2 which is connected to hosts H2 and H3 and also to device D3. This results in a solution which does not have any port violations. However, stopping at this solution would be a mistake as it is relatively costly. The next iteration results in the solution in which one of the switches is removed, and all of the hosts connect into the remaining switch, as do all of the devices, but direct connections also exist between host 1 and device 3 and also between host 3 and device 1.

This example demonstrates that even for a seemingly trivial network there are a plurality of configurations that may be solutions to the network connection problem, and that some solutions incur a greater cost penalty than others.

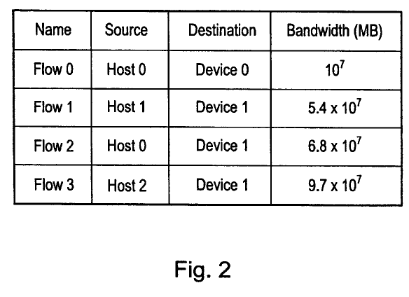

In order to exemplify the workings of an embodiment of the present invention it is helpful to consider a simple network. FIG. 2 is a table showing a network data flow definition in the form of a list specifying the connections which exist between network elements, and specifically between three hosts, labelled host 0, host 1 and host 2, and two storage devices labelled device 0 and device 1. Additionally the bandwidth requirement in MB is also specified. Thus, a first flow labelled flow 0 exists from host 0 to device 0 and has a bandwidth requirement of 10 MBs⁻¹. Flow 1 connects host 1 to device 1 and has a bandwidth requirement of 54 MBs−1. Similarly flow 2 connects host 0 to device 1 and has a bandwidth requirement of 68 MBs⁻¹, whereas flow 3 interconnects host 2 to device 1 and has a bandwidth requirement of 97 MBs⁻¹.

Ant Optimisation

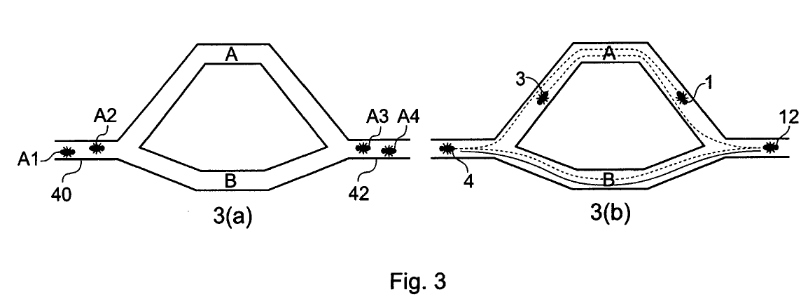

An first approach to finding the optimal solution is based on so called ant optimisation. The inspiration for ant colony optimisation algorithms comes from knowledge of path selection in ant species using pheromone trails. The ant deposits a pheromone as it walks. Thus a subsequent ant, when facing a choice of routes, will take a path which has the highest concentration of pheromone on it, as this path has had the largest number of ants travelling on it previously. If multiple paths have the same amount of pheromone, each of the equivalent paths is chosen with equal probability. Occasionally an ant will ignore the pheromone concentrations and simply pick a path randomly. It is also accepted that the pheromone evaporates at some rate over time such that paths age out. These simple rules result in an “emergent” behaviour of a colony finding the shortest path between two points. This can be shown by considering the journey of four ants, as shown in FIG. 3.

FIGS. 3a and 3b give a simple illustration of the process involved in “ant colony optimisation”. In FIG. 3a we consider the progress of ants between two points labelled 40 and 42 via two possible paths labelled A and B. Ants A1 and A2 depart from point 40 at the same time T₀. The likelihood that an ant will follow a path depends on the concentration of pheromone on that path. As FIG. 3a represents the first time that the paths are navigated, then there is no pheromone on either path A or B. Thus one ant, ant A1, progresses along the path “A” whereas the second ant, A2, progresses along the lower path “B”. Each ant travels at the same speed. Simultaneously ant A3 and A4 deport from point 42, with ant A3 taking path A and ant A4 taking path B.

FIG. 3b shows the ant positions at some time later, when the ant A2 travelling along the lower path has arrived at point 42, whereas the ant A1 travelling along the upper path is still in transit. Similarly ant A4 has arrived at point 40 whilst ant A3 is still in transit. Thus, an ant departing from point 42 at this time or just after is more likely to choose the path “B” over path A as there will be a greater concentration of pheromone on the lower path. Providing the paths are used frequently, path B will become the chosen path.

In order to optimise the network, the storage area network design problem is translated into a path optimisation that can be solved by virtual ants which act as investigation agents to investigate connections within the network. The designer assumes that a set of F flows exist through a set of N fabric nodes. The number of fabric nodes N is generally greater than the number of fabric nodes strictly necessary to solve the problem. A colony of virtual ants are then created and allowed to choose routes through the storage area network. A route in this context is the assignment of a flow f from the set of flows F to a fabric node n from the set of fabric nodes N. The routes chosen allow a network topology to be inferred.

In order to choose its path, a particular ant will iterate through a set of required flows. The flows are ordered by decreasing bandwidth requirements. The ant chooses a fabric node, or direct connection, for each of the flows that it is to pass through. As the path is constructed the set of possible nodes to which the next flow can be assigned is restricted to only those nodes which will result in a feasible network. If there are no feasible fabric node choices and the set of possible nodes is therefore empty, the ant is “terminated” and ignored. It then becomes possible to evaluate the resulting network in terms of a “cost” to implement the network. The calculation of cost is comparable to calculating the length of a particular tour. At the end of each generation, each ant updates the pheromone concentration values along its path according to a predetermined rule.

The exact probability of a particular ant choosing a particular fabric node for a particular flow during a particular generation (t) is, in general, a combination of both pheromone concentration r and heuristic desirability ξ as defined below:

$${P}_{fn}^{ k} ( t ) = \frac{{{τ}_{fn} ( t )}^{α} * {ξ}_{fn}^{β}}{{\sum }_{m ∈ Nfeasable} {{τ}_{fm} ( t )}^{α} * {ξ}_{fm}^{β}} \qquad ( equation 1 )$$

where
t=generation counter
P_{fn}^{k}(t)=probability of an ant k of a set of ants K choosing a flow f from a set of flows F via a fabric node n of a set of fabric nodes N
τ=pheromone concentration
ξ=heuristic desirability
m (like n) is an index counting over the fabric nodes
α and β are constants for the duration of each run.

It is assumed that there are K ants in each generation t. The probabilities are normalised by dividing the numerator by the sum of all feasible choices N_{feasible} in order to ensure that the probabilities sum to 1. These feasible choices are those known choices that are consistent with a path corresponding to a buildable network. The probability of selecting an infeasible node is 0, and equation 3 gives the probability of selecting each of the feasible nodes. If there are no feasible nodes, then the ant has reached a “dead end” and it and the path are terminated.

In order to evaluate equation 1 it is necessary to determine the pheromone values. In order to do this, the pheromone values may be stored in a matrix which has dimensions F by N. The pheromone values of a particular route, that is flow f assigned to a fabric node n, is then determined by accessing the matrix at location (f, n). Initially each position of the matrix is initialised at the start of a run with a preset value. At the end of each run, which constitutes a generation, the pheromone levels are updated according to the formulas specified in accordance with equations 2 and 3 below:
τ_{fn}(t+1)=(1−P)*τ_{fn}(t)+D_{kb} (equation 2)
τ_{fn}(t+1)=(1−P)*τ_{fn}(t) equation 3)

In each case P is a constant representing a coefficient of decay. The coefficient of decay models the rate of evaporation for the pheromone between each run. A particular route's pheromone concentration is only updated by a particular ant if the ant's path has passed through that location.

Equations 2 and 3 correspond to a form elitism. Equation 2 is used for all routes (f, n) which have been traversed by the best ant in the generation. Equation 3 is used for all other routes. D_{kb} is either set to a constant or is set such that the increase in pheromone at this point is inversely proportional to the cost of the solution specified by the best ant K_{b}.

It is also necessary to determine the heuristic desirability value. For our purposes we will define ξ for the heuristic desirability as an undesirability and choose β to be negative so that the term ξ^{β} in equation 1 represents a weighted desirability. The concept of undesirability can express several ideas, namely:
1. Adding a fabric node early on is not necessarily bad, but adding a fabric node toward the end of the list of flows probably results in too much left over fabric node bandwidth.
2. If there is already a lot of unallocated fabric node bandwidth, there is no need for another fabric node.
3. Port packing (for a particular host of device) is harder if lots of flow remains to be allocated.
4. Port packing is easier if there is lots of port bandwidth (i.e. lots of port) available.
5. Port re-usability is greater if there is more available bandwidth on the fabric node that carries the flow we have just added.

Undesirability ξ is defined as a combination of the undesirability of adding a particular new fabric node (Uₙ) and the undesirability of adding new ports (U_{Ph}, U_{Pd} or U_{Pn}) on a host, device, or fabric node respectively. The heuristic undesirability Uₙ of adding a particular new fabric node (n) is influenced by ideas (1) and (2) above, and is given as a formula in equation 6.

$${U}_{n} = ( {\sum }_{m ∈ Nused} {B}^{rem} ( m ) ) / ( {\sum }_{g = f + 1}^{\vert F \vert} b ( g ) ) \qquad ( Equation 4 )$$

Here B^{rem}(m) is the remaining bandwidth available on the already used fabric nodes N_{used}, b(g) is the bandwidth required for flow g, and the sum Σ_{g=f+1}^{|F|} is over flows not yet assigned.

The undesirability U_{Ph}, U_{Pd} or U_{Pn} of adding a new port, is influenced by ideas (3), (4) and (5) above, and is defined in Equation 5.

$${U}_{Ph \vert d \vert n} = \frac{{\sum }_{g - f + 1}^{\vert F \vert} b ( g ) * {K}_{h \vert d \vert n}}{{B}_{used\_port}^{rem} * {\sum }_{m ∈ {N}_{used}} {B}^{rem} ( m ) + {C}_{d}} \qquad ( Equation 5 )$$

In this equation B_{used}_{_{—}}ₚₒᵣₜₛ^{rem} is the sum over each node of the remaining bandwidth of each of its used ports, C_{d} is a constant representing the cost of a direct connection, and Kₕ, K_{d}, and Kₙ are constants associated with each type of fabric that has ports. K reinforces the difference in cost associated with adding a switch port versus a host port versus a device port.

The undesirability of a new route is defined to be one plus the sum of all relevant undesirabilities. For example, if the route does not require the addition of any new fabric elements, then ξ=1; if it only requires a new host port is added, ξ=Uₚₕ; if the route requires that a new fabric node and fabric node port are added to the network, ξ=Uₙ+Upₙ+1, etc. No monetary cost term in the heuristics is included. That is, there is distinction, in term of ξ, made between different fabric node choices because of the monetary cost associated with that choice. This is something that is expected to be learned by the system. Since only the best ant updates the pheromone table, and the monetary cost f the network specified by that ant is incorporated into the updated pheromone values, as in equation 6, more cost effective routes are reinforced through τ.

Finding the Best Ant in the Colony

The best ant in a generation is determined by comparing number of port violations, amount over-allocated bandwidth, and monetary cost of each ant's resulting network. It is desirable to make a distinction between host or device port violations and fabric node port violations. This is because of the idea that it is harder to resolve host/device port violations than fabric node port violations, since a fabric node generally can support more ports (8-16) than a host or device (2). This makes one host/device port violation more significant than a fabric node port violation. When two ants are compared, it is beneficial to first look at the relative number of host/device port violations. An ant specifying a network with a smaller number of these type of port violations is considered to be better than the ant with a greater number. If two ants have the same number of host/device port violations, then the number of fabric node port violations is examined. If necessary the amount of overused bandwidth is compared, followed by monetary cost of each of the networks. Determination of the best ant in a colony is used when updating the pheromone matrix using equations 2 and 3. An equation similar to equation 2 can be used to calculate a cost (which is the inverse of the fitness) for each ant.

Consider one generation of two ants attempting to solve a four flow problem as shown in FIG. 2 with two switches available for use. Each switch has a capacity of 160e07 MB/s. Table 1 below shows the initial pheromone matrix.

TABLE 1

| | Flow3 | Flow2 | Flow1 | Flow0 |
|---|---|---|---|---|
| directConnection | 0.1 | 0.1 | 0.1 | 0.1 |
| switch0 | 0.1 | 0.1 | 0.1 | 0.1 |
| switch1 | 0.1 | 0.1 | 0.1 | 0.1 |

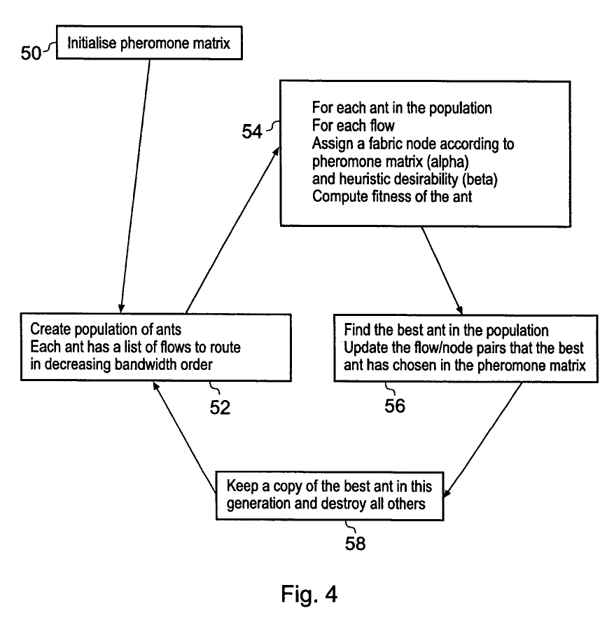

We can then begin the search through a solution space using virtual ants. FIG. 4 shows the processes performed in ant optimisation of a network. The process commences at step 50 where a pheromone matrix of a suitable dimension F, N is created and initialised (F=number of flows, N=number of fabric nodes). From step 50 control is passed to step 52 where a population of ants is created and each ant has a list of data flows to route in decreasing bandwidth order. From step 52 control is passed to step 54. Step 54 defines a process where for each ant in the population and for each data flow for a given ant a fabric node is assigned to the dataflow in accordance with the values of the pheromone matrix and the heuristic desirability. Then the fitness (inverse cost) of each ant is calculated. From step 54 control is passed to step 56 where an investigation of the fitness of each ant is performed to find the best ant (fittest or least costly) in the population and then the pheromone matrix is updated in accordance with equations 4 and 5. Control then passes to step 58 where all ants except the best and are destroyed. Control then passes to step 52 where a new population of ants is created, the population including the best ant from the previous generation.

The process is repeated for a predetermined number of iterations. For simplicity in calculations we will set α=Kₕ=K_{d}=Kₛ=C_{d}=1 and β=−1. These values, while serving to simplify drastically the following algorithm demonstration, are not realistic settings as they produce large unwanted disparities in the values calculated. The maximum bandwidth available on each port is 10e07 MB. Starting with the first ant (ant 0), we solve equation 3 for each possible routing choice for the first flow. Beginning with a direct connection as the first routing choice, the value τ is obtained exactly from the pheromone matrix for the particular flow (flowf) and routing choice (directionConnection).

The value of ξ is slightly more complex, and in this case it is calculated based on the need to add a new host port, and a new device port in order to route a flow from host 2 to device 1. Therefore for flow 3 to be a direct connection we can solve ξ=U_{Pn}+U_{Pd}+1 as illustrated in equation 6.

$$\begin{matrix}ξ = \frac{{\sum }_{{f}_{remaining}} B * ( {K}_{h} )}{( {\sum }_{{p}_{used}} {B}_{a} ) * ( {\sum }_{{n}_{used }} {B}_{a} ) + {C}_{d}} + \\ \frac{{\sum }_{{f}_{remaining}} B * ( {K}_{d} )}{( {\sum }_{{p}_{used}} {B}_{a} ) * ( {\sum }_{{n}_{used }} {B}_{a} ) + {C}_{d}} + 1\end{matrix} \qquad ( Equation 6 )$$

The value of Σ_{ƒremaining}B is 6.8e07+5.4e07+1.0e07=13.2e07. The amount of remaining bandwidth available on the ports available in the system, is calculated as the maximum amount of bandwidth available from each port multiplied by the number of ports and then subtracting off the amount of bandwidth used once this flow has been allocated on this fabric node. Therefore Σ_{Pused}B_{α}=10e07*2-9.7e07*2=0.6e07. The amount of fabric node bandwidth available is zero, as when flow 3 is routed directly there are no fabric nodes in the network. As such ξ becomes

$${U}_{Ph} + {U}_{Pd} + 1 = \frac{13.2 e 07 \times 1}{0.6 e 07 \times 0 + 1} + \frac{13.2 e 07 \times 1}{0.6 e 07 \times 0.1} + 1 = 26.4 e 07.$$

We repeat this series of calculations for each of the other potential routes for flow 3: switch 0 and switch 1. The value of ξ for the probability of choosing switch 0 or switch 1 is composed of U_{Ph}, U_{Pd}, U_{Pn} and Uₙ as each of a new host, device and fabric node parts would have to be added to the network in addition to a new fabric node. The computed values of Uₓ for switch 0 and switch 1 set out in table 2 below:

TABLE 2

| | Uₛ | U_{Ph} | U_{Pd} | U_{Pa} |
|---|---|---|---|---|
| directConnection | 0 | 13.2e07 | 13.2e07 | 0 |
| switch0 | 12.12 | 6.875e−09 | 6.875e−09 | 6.875e−09 |
| switch1 | 12.12 | 6.875e−09 | 6.875e−09 | 6.875e−09 |

With knowledge of the appropriate value of τ and ξ for each of the possible choices for routing of flow 3, it is then possible to compute the appropriate probability of selecting each choice. The probability P_{flow3, switch}3 of selecting switch 0 is computed in equation 7.

$$\begin{matrix}{P}_{flow3 , switch0} = \frac{{τ}_{flow3 , switch0}^{α} \times {ξ}_{flow3 , switch0}^{β}}{{\sum }_{node} {τ}_{flow3 , node}^{α} \times {ξ}_{flow3 , node}^{β}} \\ = \frac{{( 0.1 )}^{1} \times {( 12.12 )}^{- 1}}{\begin{matrix}{( 0.1 )}^{1} \times {( 2.64 \times {10}^{8} )}^{- 1} + {( 0.1 )}^{1} \times \\ {( 12.1 )}^{- 1} + {( 0.1 )}^{1} \times {( 12.1 )}^{- 1}\end{matrix}} \\ = \frac{0.00825}{3.79 \times {10}^{- 10} + 0.00825 + 0.00825} \\ = 0.5\end{matrix} \qquad ( Equation 7 )$$

We can also compute P_{flow3,switch1} and P_{flow3,directConnection}in this manner, the results of which are shown in table 3 below:

TABLE 3

| | flow3,node |
|---|---|
| directConnection | 0.0 |
| switch0 | 0.5 |
| switch1 | 0.5 |

We then allow ant 0 to choose a route for flow 3 following the computed probabilities. For the sake of this example we will choose switch 0. Once the first route has been selected, the ant will then compute probabilities for flow 2 (the second flow in the series presented), as shown in the table 4, and choose a route, say through switch 0 again. Routes are then chosen for flow 1 and flow 1 in the same manner.

TABLE 4

| | Flow2,node |
|---|---|
| directConnection | 0.49 |
| switch0 | 0.49 |
| switch1 | 0.02 |

Once ant 0 has chosen its path, ant 1 also compiles a set of routes similarly (this may be done in parallel). Once all ants have designed a network by choosing routes for each flow, this completes the end of the generation, and pheromone matrix is now updated.

The value with which a particular location in the matrix changes may be computed in several ways depending on the particular use of the algorithm (i.e. using elitism or letting all ants attract the pheromone matrix at different levels). In this example we will use elitism with all flow/fabric node pairs which the best ant (k_{b}) has chosen incremented by a fixed amount Dk_{b}=0.1. If we assume that ant 0 choose switch 0, switch 0, switch 0, and a directConnection for flow 3, flow 2, flow 1, flow 0 respectively, and ant 1 choose to route all flows through switch 1, comparing the network design arising from these two sets of choices we see that ant 0 is better ant 1. The updated pheromone matrix appears in table 5 where the decay rate (p) is set to 0.1.

TABLE 5

| | Flow3 | Flow2 | Flow1 | Flow0 |
|---|---|---|---|---|
| directConnection | 0.09 | 0.09 | 0.09 | 0.19 |
| switch0 | 0.19 | 0.19 | 0.19 | 0.9 |
| switch1 | 0.09 | 0.09 | 0.09 | 0.9 |

Thus a routing can be derived by picking the most favoured flows.

“Genetic Optimisation”

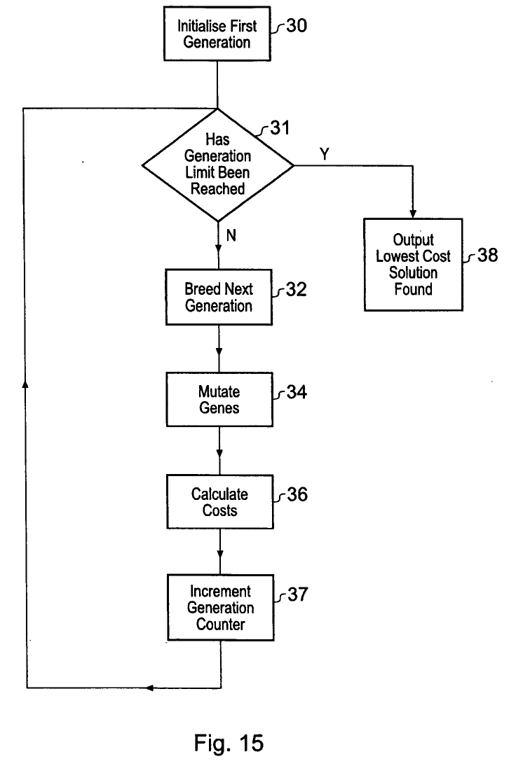

Potential solutions to the SAN problem (and indeed general network problems) can be investigated using genetic optimisation. A description of the genetic techniques used to cause genetic modification of an Iₜₕ set of network configurations to derive an (I+1)ₜₕ set of network configurations, which represents a next generation of solutions and hence are children of the parent solutions in the Iₜₕ set of solutions, will be described. However in summary (and as will be described later with reference to FIG. 15) a current generation containing a plurality of possible solutions to the network problem acts as a pool of parents for a new generation of solutions. Two parents breed to form each new “child” solution and each child inherits attributes from its parents. Furthermore random mutations also occur in order to give rise to the possibility that unexpected changes to the nature of the child solutions may occur. Each child solution is then evaluated and the best solutions (or least bad solutions) are given preference when breeding the next generation.

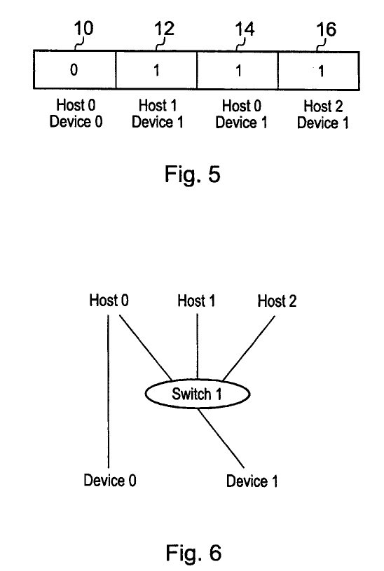

The connections between the hosts and devices as set out in FIG. 2 can be represented by a “genome” as shown in FIG. 5. Since only 4 data flows, flow 0 to flow 3 are required then the genome has only 4 elements or genes, 10, 12, 14 and 16 in it. The first element 10 represents the interconnection path from host 0 to device 0, second element 12 represents the interconnection between host 1 and device 1 and so on. Thus the genome can be extended to any length required in order to satisfy the connection requirements as initially defined by the network designer. Each element within the genome specifies the connection path. In this example “0” represents a direct connection between devices, ie between the host and the storage device. A “1” represents a connection routed via fabric elements, i.e. via a first switch, switch 1, a “2” represents a connection routed by a second switch, S2, and so on. Therefore the genome 0111 shown in FIG. 5 specifies or encodes the network topology shown in FIG. 6.

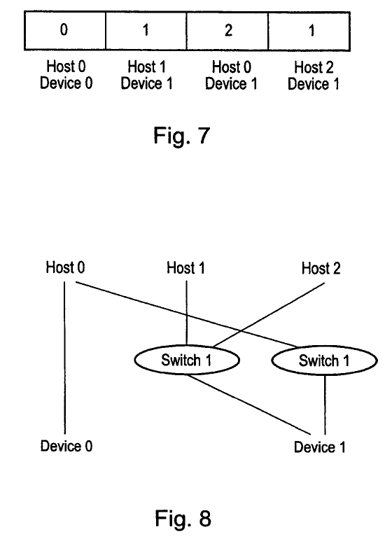

An alternate genome 0121 as shown in FIG. 7 gives rise to the topology shown in FIG. 8.

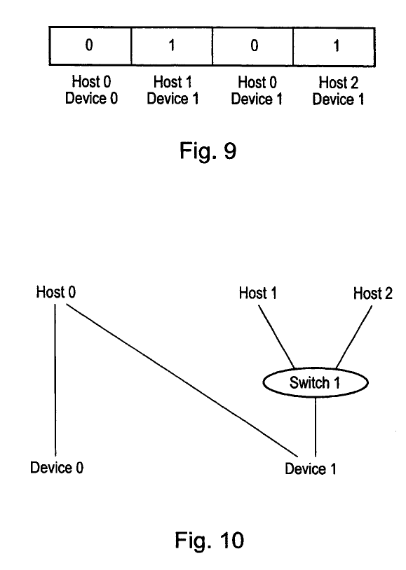

A further genome 0101 as shown in FIG. 9 and the resulting topology is shown in FIG. 10.

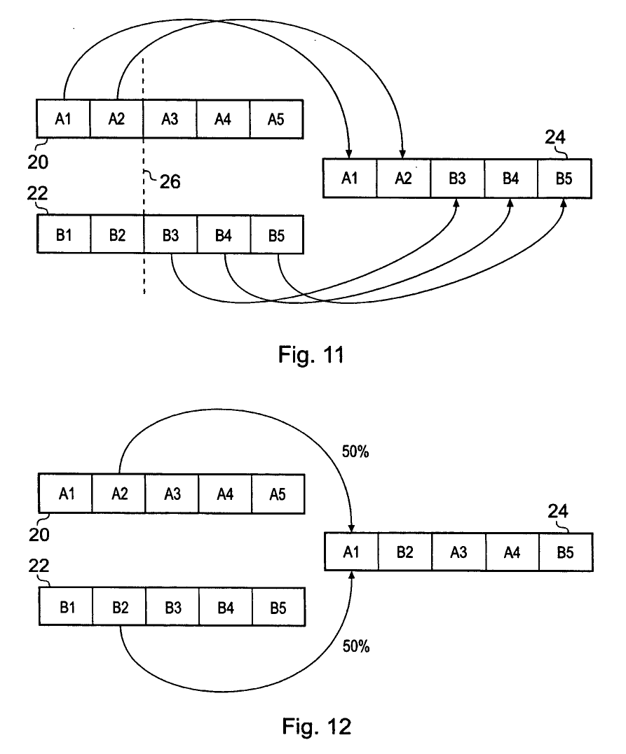

In genetics, it is well known that a genome can change through a combination of two processes. One of these is combination of the partial attributes of two genomes to create a new genome, and the other process is mutation where one or more genes within the genome may become altered. Returning to FIGS. 5 to 10, it can in fact be seen that each of the three networks shown results from the mutation of the third gene 14 specifying the interconnect arrangement between host 0 and device 1. All other genes within the genome remain unchanged within each of these three examples. Combination of genomes is analogous to the breeding of solutions. The combination can occur in different ways as illustrated in FIGS. 11 and 12. In FIG. 11 two genomes 20 and 22 are breed to produce a new genome 24. In this process a boundary 26 is arbitrarily selected. Thus, for example, in a genome comprised of twenty genes, the position at which a boundary might be placed is arbitrarily scanned across the genome and a random decision is made at each possible position whether the boundary will be placed there or not with, for example, a 5% probability that the boundary will be placed at an edge of a genome and hence a 95% probability that it will not. This allows for the possibilities that the offspring can be identical to parent 20, identical to parent 22, or a mixture of the two. In the example shown in FIG. 11, the boundary 26 occurs between the second and third genes and hence the first two genes A1 and A2 of the first parent 20 are propagated into the offspring 24 whereas the final three genes B3, B4 and B5 are propagated into the offspring 24. In general if a genome is composed of N genes, then the chance of placing a boundary between consecutive genes 1/N.

In the alternative breeding arrangement shown in FIG. 12, for each gene within the genome an independent choice is made as to it would be propagated with the corresponding gene from the parent 20 or the corresponding gene from the parent 22. Each parent has, in this example, a 50% chance that one of its genes will be chosen for any specific gene position. Thus the resulting child no longer inherits the first part of its genome from one parent and the second part from the other parent, but instead has them randomly distributed. Gene selection can be weighed by the cost associated with each parent such that the genes from the less costly parent are favoured.

In the breeding process, mutations naturally occur and hence the mutation process may be applied to the genomes produced by the breeding process. In general, mutation occurs at a low rate and hence for each gene in the genome a mutation function is applied to it where the far greater probability is that the gene will be left unaltered. However there remains a small possibility that any gene will be marked for change, and then once a gene is marked to mutate a further randomisation can be performed in order to change the content of that gene to a new value 0, 1, 2, 3, and so on. Hence numbers 1, 2 and 3 represent switches 1, 2 and 3 (and so on). The randomisation process is preferably weighted against the insertion of a new switch or other fabric element, with the weighting against the insertion of a new switch increasing as the number of iterations or generations have increased. This tends to stop the system from introducing new high cost solutions late on into the optimisation process.

Evaluation of Solutions

Each genome represents a SAN which is a theoretically viable solution. However as the trivial example in FIG. 1 served to illustrate, some solutions are more costly than others. It therefore becomes necessary to test each possible solution for its cost, both in terms of expensive components and in terms of the number of violations which the solution incurs. Some violations are “hard” and hence would result in the effective dismissal of a solution, whereas some violations are relatively “soft” (for example because a bigger router having more ports could be bought at relatively low cost) and hence solutions with soft violations may be maintained.

Thus for each network a cost is computed. The cost can be computed in many ways and an exemplary cost computation is given in equation 8:
C=W₁C_{M}+W₂P_{hd}+WₑP_{f}+W₄b (equation 8)

The coefficients W₁, W₂, W₃ and W₄ represent the relative importance of each cost term. The terms Cₘ, P_{hd}, P_{f} and b represent, respectively, the monetary cost of each of the components necessary, the number of host or storage device port violations, the number of fabric node port violations, and the amount of bandwidth in any communications channel which is in excess of the capability of that channel to carry.

The terms Cₘ, P_{hd}, P_{f} and b are advantageously normalised to lie between zero and one. This is achieved by dividing the term by an over approximation of their worst case values. Thus, for example, the worst case monetary cost C_{mw} is approximated by the following formula:
C_{mw}=(Nₕ+Cₕ)+N_{d}*C_{d})+(N_{f}*2)*(Cₗ+max(Cₚ))+N_{f}*maxC_{f}) (equation 9)
where
Nₕ=number of hosts
N_{d}=number of storage devices
N_{f}=number of flows
Cₕ=cost of host
C_{d}=cost of storage device
C_{f}=cost of comms link (fiber/cable)
Cₚ=cost of port

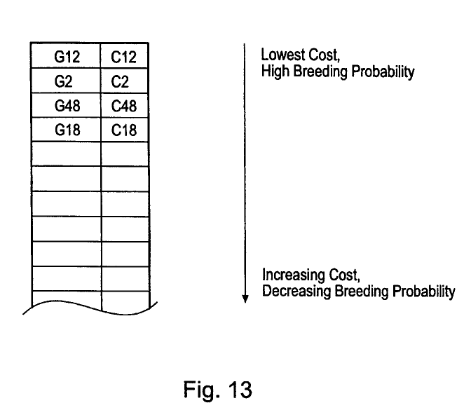

Thus each possible solution is evaluated for its financial cost and its “badness” of unbuildability due to port violations or bandwidth violations. Typically each iteration of the genetic algorithm can be considered as being a new generation, and the number of individuals (and hence possible solutions) may be constrained. Therefore in each generation the possible solutions can be evaluated and then ranked in order of cost. FIG. 13 schematically illustrates a cost table computed for a generation. The cost table is ranked starting with the lowest cost solutions. Thus in this example, the lowest cost solution is genome G12 having an associated cost C12. The next lowest cost solution is G2 with a cost C2, then G48, then 18 and so on.

From the cost table, individuals are selected to form the next generation by breeding. To creating new offspring, two parents from the existing generation are selected randomly, but with those having a lower cost being given preferential weighting compared to those parents having a higher cost. A parent is not removed from the table after it has been used for breeding, and hence may breed several times, with different partners. Thus lower cost solutions can be regarded as being promiscuous. Furthermore elitism may be applied so that the lowest cost solution, in this case G12 is also copied directly into the next generation thereby persevering its genome intact. The breeding process as described with respect to FIGS. 11 and 12 is then repeated a predetermined number of times in order to bring the population of that generation up to the required number. Following the breeding process, the mutation process is then applied. In general, because the chance of mutating any single gene is quite low, the vast majority of the genomes will be left unaltered. However it is expected that several genomes within any generation will be subject to mutation. The version of G12 copied in form the previous generation because it was the lowest cost solution is protected from mutation so as to prevent the process of elitism from being subverted by mutations. Following the application of the breeding and mutation processes, the new generation is then tested for its cost, the individual genomes ranked by cost, and then allowed to breed for a further generation. This process is repeated for a predetermined number of generations or until such time as reduction of cost has not occurred for a predetermined number of generations.

In the example considered hereinbefore the network has only been one layer deep, i.e. there has been one switch or hub between devices. However, this has only been the case so as to keep the example simple and in practice networks may have several layers. Consider for example a network having three servers S1, S2, S3 that are to connect to three user devices D1, D2 and D3 via a network of two layers. We may constrain the solutions by specifying that Each layer can have four elements in it and the maximum number of ports on a device is 6.

Let the flows F (each denoted as [server_id,device_id]) be: [1,1],[1,2],[1,3],[2,1],[3,2],[3,3].

Then a flow for this application is denoted:
[server_id,[layer1_slot,layer1_vote],[layer2_slot,layer2_vote],device_id]
   so one potential genome is the six flow is:
[1,[4,c],[2,s],1],
[1,[2,c],[2,s],2],
[1,[1,h],[2,c],3],
[2,[1,h],[1,c],1],
[3,[4,c],[1,h],2],
[3,[4,h],[3,s],3].

In that genome the votes (i.e. the status of a slot) for each slot in layer 1 are:
Slot1: h, h. (instantiated to Hub)
Slot2: c. (instantiated to Clear)
Slot3: no votes. (instantiated to Clear)
Slot4: c,c,h. (instantiated to Clear)

And the votes for each slot in layer 2 are:
Slot1: c,h (TIE—instantiated to Clear
Slot2: c,s,s, (instantiated to Switch)
Slot3: s. (instantiated to Switch)
Slot4: no votes (instantiated to Clear)

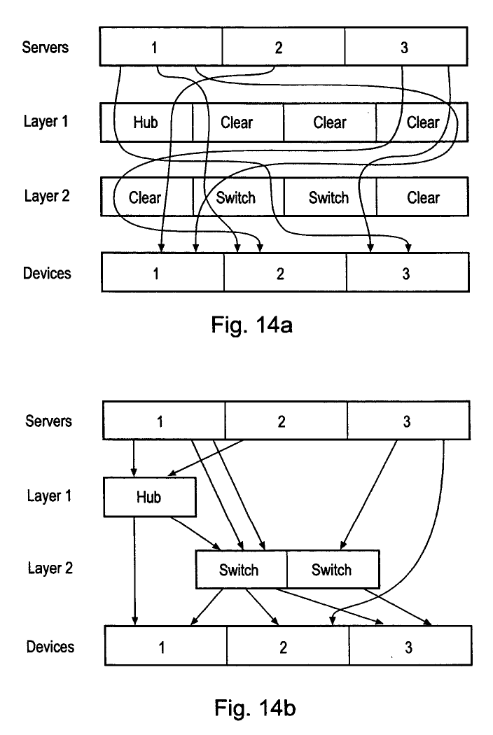

With these instantiations, the network flows can be drawn as shown in FIG. 14a which can then be redrawn in simplified form as FIG. 14b.

It can be seen that the single layer approach can be extended to define genomes for use in a multi-layer network. Once the genomes have been established they can be combined and mutated using the processes described for the single layer genomes, and then the cost of implementing each solution tested as described hereinbefore. Thus the extension to multi-layer system is easy to perform.

FIG. 15 schematically illustrates a flow chart for implementing the genetic solution of a SAN problem. This solution can be implemented on any suitable programmed data processor. Such a data processor will typically include an input/output device such as keyboard and display and printer, together with a central processing unit having access to long term storage, for example in the form of a magnetic disc, together with short term storage which typically will be fabricated in semiconductor random access memory.

The computer implements the process illustrated in FIG. 15 by initialising a first generation of solutions at step 30. The first generations of solutions may include a population of identical genomes because some of these become altered via the mutation process. It is advantageous with any fitting problem that the initial guess should be relatively sensible and hence the first generation is advantageously based on the standard network solutions which SAN designers often seek to implement. From step 30 control is passed to step 31 where a test is made to see whether a generation limit has been reached. From step 31 control is passed to step 32 where the next generation, typically the I+1ₜₕ generation is bred by combining the genes of the current, Iₜₕ, generation. After the breeding or combination process, control is passed to step 34 where the mutation process is applied such that some of the population of genomes within the just created generation have their genes altered. From step 34 control passes to step 36 where an evaluation of the cost of implementing an SAN is performed for each genome in the present generation. Step 36 associates each genome with its cost and advantageously ranks them in order such that this information can be used in order to give a weighting to the probability that a member of the generation will be chosen to be a parent in the breeding process for the next generation next time step 32 is implemented. From step 36 control is passed to step 37 where a generation counter is incremented and then control is passed to step 31 again. If step 31 determines that a generation limit has been reached, that is the required number of iterations have occurred, then control is passed to step 38 where the lowest cost solution is output. The techniques described herein can be run in sequence such that, for example, an “ant” based solution can act as a seed for genetic optimisation.

1. A method of optimising a storage network comprising the steps of:
a. defining a plurality F of flows through a set N of fabric nodes;
b. investigating the cost of establishing some routes through the storage network; and
c. updating a route desirability variable as a function of the cost.

2. A method as claimed in claim 1, in which the steps b) and c) are repeated a plurality of times.

3. A method as claimed in claimed in claim 1, in which the desirability of non-optimal routes is decreased whereas the desirability of the optimal route is increased each time step c) is performed.

4. A method as claimed in claim 1, in which the routes are investigated using investigation agents which exhibit ant behaviour.

5. A method as claimed in claim 1, in which the number of fabric nodes N defined by a user is greater than the number of fabric nodes required to solve the storage area network problem.

6. A method as claimed in claim 1, in which an ant can choose a direct connection between device or a connection via a fabric node.

7. A method as claimed in claim 1, in which the routes defined by the ants are evaluated to determine a cost of the connection.

8. A method as claimed in claim 4, in which the probability of an ant choosing a connection is a function of a pheromone concentration applicable to that connection.

9. A method as claimed in claim 8, in which the pheromone concentration decays at a predetermined decay rate.

10. A method as claimed in claim 8, in which the pheromone concentration is increased when an ant picks the connection.

11. A method as claimed in claim 8, in which the probability of an ant choosing a route is a function of a route's desirability.

12. A method as claimed in claim 11, in which an undesirability of choosing a route is a function of the cost of adding a fabric node, unallocated bandwidth at a fabric node, and port packing at a device.

13. A method of optimising a storage network configuration, the method comprising the steps of:
a. taking an Iₜₕ set of network configurations and using genetic modification to derive from the Iₜₕ set of configurations an (I+1)ₜₕ set of configurations having at least one change applied to them, and
b. computing a cost for at least some of the configurations of the (I+1)ₜₕ set.

14. A method as claimed in claim 13, in which the method is repeated a plurality of times, and the likelihood that a configuration of a Iₜₕ set will be used derive one or more configurations in an (I+1)ₜₕ set is an inverse function of the cost associated with implementing that configuration.

15. A method as claimed in claim 13, in which a network configuration is specified as a network flow definition, and the flow definition can be further simplified to a genome expressing the interconnections between network elements, and an (I+1)ₜₕ set is derived by applying at least one of combination and mutation to genomes of the Iₜₕ set.

16. A method as claimed in claim 13, in which the combination process combines a first portion of a first genome with a second portion of a second genome, the contributions of each genome being defined by a randomly positioned boundary.

17. A method as claimed in claim 13, in which steps a and b are repeated a predetermined number of times.

18. A method as claimed in claim 13, further comprising a preceding stage of optimising by
a). defining a plurality F of flows through a set N of fabric nodes;
b). investigating the cost of establishing some routes through the storage network.

19. A computer program for causing a programmable computer to perform a method of optimising a network comprising the steps of:
a) defining a plurality F of flows through a set N of fabric nodes;
b) investigating the cost of establishing some routes through the network; and
c) updating a route desirability variable as a function of the cost.
